(19) United States
(12) Patent Application Publication
(10) Pub. No.: US 2015/0358305 A1
(43) Pub. Date: Dec. 10, 2015

(54) Service Invitation Token

(71) Applicant: Basware Oyj, Espoo (FI)

(72) Inventors: Mika VÄNSKÄ, Espoo (FI); Bogdan ONOIU, Espoo (FI); Pekka IMMONEN, Espoo (FI)

(21) Appl. No.: 14/723,557

(22) Filed: May 28, 2015

(30) Foreign Application Priority Data
Jun. 4, 2014 (FI) 20140167

(51) Int. Cl. H04L 29/06

(52) U.S. Cl. CPC H04L 63/08; H04L 63/20

(57) ABSTRACT

The invention discloses a computer executable method for a first computer system to amend a transaction with an invitation token to invite a user to use a service provided by a second computer system wherein the service is subscribed by the first system. The method is characterized in that it comprises steps for requesting by the first computer computer system the creation of the invitation token using information indicating a trust relationship between the first computer system and the second computer system, and amending by the first computer system the transaction with a URL comprising the created invitation token. The amended transaction is sent to the recipient system. A method for using the invitation token to invoke an application service is also disclosed.

### BACKGROUND

In a transaction transmission network such as an electronic invoice transmission network, transaction data is often transmitted from a sender to the receiver via at least one operator. The operator may support some standard format in its communication with the customers and/or with other operators. The operator may also provide some value-add services that are based on the standard-compliant data. However, there may also be a need for supplementary data and/or services related to the standard transaction that e.g. one of the operators of the transmission chain or the recipient of the transaction is not able to support. In such case, the operator should be able to accept e.g. the supplementary data from the source of the transaction and route it further to an external system that is able to provide the service e.g. to the recipient of the transaction and provide a reliable way for the recipient to invoke the service in the external system.

An object of the invention disclosed hereinafter is thus to provide a method and an arrangement for providing at least one transaction-related service to e.g the recipient of the transaction in an external system. The provided services should preferably be possible to be subscribed for the recipient e.g. by the sender or the transaction or a service provider, e.g. routing operator, associable with the sender.

### BRIEF DESCRIPTION OF THE INVENTION

An aspect of the present invention may be a computer executable method for a first computer system to amend a transaction adapted to be sent from the first computer system to a recipient system with an invitation token to invite a recipient system's user to use a service provided by a second computer system. The method may be characterized e.g. in that it comprises steps for requesting by the first computer system the creation of the invitation token comprising information indicating a trust relationship between the first computer system and the second computer system, amending by the first computer system the transaction with a URL comprising the created invitation token, and sending the amended transaction to the recipient system.

In an embodiment, the invited user is the receiver of the transaction wherein the transaction is arranged to be transmitted from a sender to a receiver in a transaction transmission network. The network may comprise at least one operator system.

In an embodiment, the application service may be subscribed at the second computer system for the receiver user by a user representing a service provided by the first computer system.

In an embodiment, the invitation token does not comprise indication of an individual subscribed application service.

In an embodiment, the data of the invitation token comprises a hash value calculated from at least the information indicating the trust relationship between the first computer system and the second computer system.

In an embodiment, the step of requesting by the first computer system the creation of the invitation token comprises the steps of sending an authenticated request message to the second computer system and receiving from the second computer system a response message comprising the requested token. The information indicating a trust relationship between the first and the second computer system may in this embodiment comprise e.g. secret information stored in the second system. The secret information may be associable e.g. with a user account representing the first computer system in the second computer system. The credentials of the user account may be used in the authentication of the request message.

In an embodiment, the step of requesting by the first computer system the creation of the invitation token comprises invoking a service in the first computer system to create the invitation token. In this embodiment, the information indicating a trust relationship between the first and the second computer system may comprises e.g. a secret shared between the first and the second computer system.

In an embodiment, the data of the invitation token further comprises at least one of the identifier of the origin of the transaction, the identifier of the type of the transaction, the identifier of the transaction, and the timestamp of the transaction.

In an embodiment, the method further comprises the step of sending the amended transaction to a third computer system. The third computer system may be adapted to receive transactions addressed to the recipient of the transaction.

In an embodiment, the method further comprises the step of sending supplementary data related to the amended transaction to the second computer system.

Another aspect of the present invention may be a computer executable method for resolving at least one application service for the recipient of a transaction of an aspect of the present invention in an application service providing system. The method may be characterized in that it comprises steps for receiving by the computer an invitation token comprising information indicating a trust relationship between the application service provider system and a second system that amended the transaction with the invitation token, verifying by the computer the validity of the invitation token, and resolving by the computer at least one service at the application service providing system made available for the recipient of the transaction by the second system.

Another aspect of the present invention may be an arrangement comprising at least one server computer. The arrangement is adapted to comprise computer executable means for performing the steps of at least one of the methods disclosed herein.

Yet another aspect of the present invention may be a method for providing a service on a transaction in a first computer system communicatively connectable to at least one second and at least one third computer system. The method may be characterized in that it comprises e.g. steps for storing information indicating a trust relationship between the first system and the second system, receiving from the second computer system the identifier of the transaction and some data associable with the transaction, associating at least one service with the transaction, receiving an invitation token from a third computer system wherein the invitation token comprises the transaction identifier and data derived from the data indicating trust between the first system and the second system, validating the received invitation token using the information indicating trust relationship between the first and the second system, and executing the service associated with the validated invitation token.

Yet another aspect of the present invention may be a first computer system communicatively connectable to at least one second and at least one third computer system and adapted to provide a service on a transaction. The first computer system may comprise e.g. means for storing information indicating a trust relationship between the first system and the second system, receiving from the second computer system the identifier of the transaction and some data associable with the transaction, associating at least one service with the transaction, receiving an invitation token from a third computer system wherein the invitation token comprises the transaction identifier and data derived from the data indicating trust between the first system and the second system, validating the received invitation token using the information indicating trust relationship between the first and the second system, and executing the service associated with the validated invitation token.

Yet another aspect of the present invention may be a tangible computer readable memory medium comprising a computer program product. The product may be adapted to comprise computer executable instructions for the purpose of performing at least one combination of steps of at least one of the methods disclosed herein.

### DRAWINGS

Some preferred embodiments of the invention are described below with references to accompanied figures, where:

FIG. 1 shows an exemplary computer arrangement of an embodiment of the present invention,

FIG. 2a depicts an event diagram disclosing an aspect of an embodiment of the present invention,

FIG. 2b depicts an event diagram disclosing another aspect of an embodiment of the present invention,

FIG. 3a illustrates in the form of a flow chart the method of amending a transaction with an invitation token according to an embodiment of the present invention,

FIG. 3b illustrates in the form of a flow chart the method of creating an invitation token for a transaction according to an embodiment of the present invention,

FIG. 3c illustrates in the form of flow charts the methods of using an invitation of an embodiment of the present invention, and

FIG. 4 depicts functional components of a server or terminal computer usable as the computer of various embodiments of the present invention.

### DETAILED DESCRIPTION OF THE INVENTION

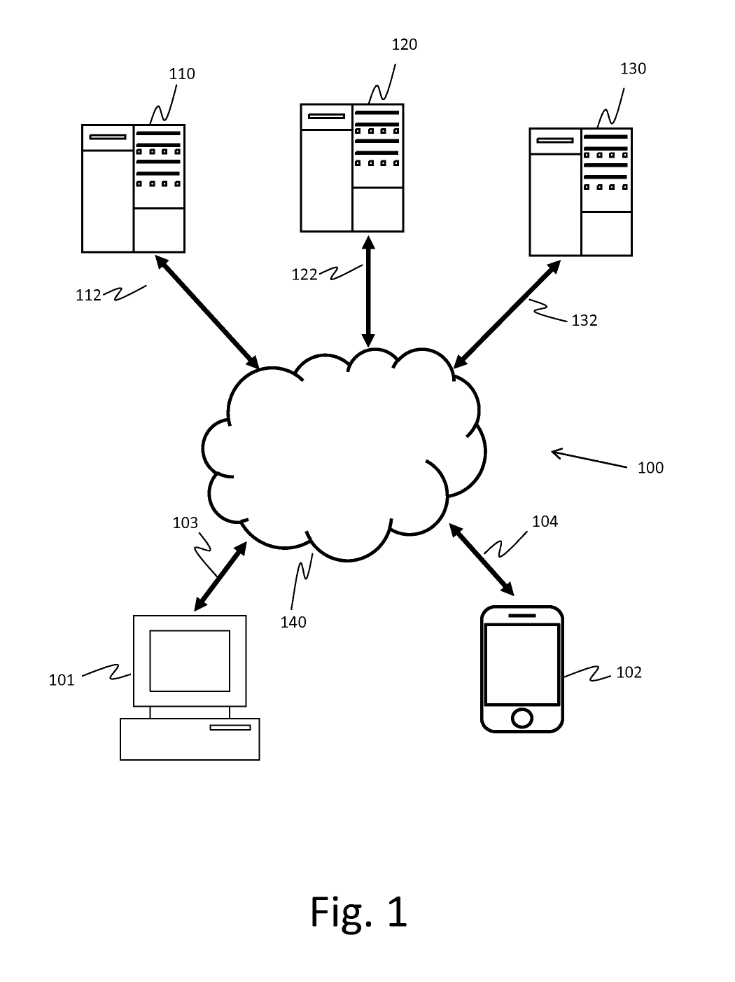

FIG. 1 depicts a computer and data communication arrangement 100 according to a preferred embodiment of the present invention. The arrangement comprises a computer system 110 acting as a source of transactions in a transaction transmission network, a computer system 130 acting as destination of transactions in the transaction transmission network and a computer system 120 acting as an application service provider for transactions transmitted from the source of transactions 110 to the destination 130 of transactions. The computer systems 110, 120 and 130 are communicatively connected to a data communication network 140, e.g. a TCP/IP network, e.g. the Internet, using data communication connections 112, 122, 132. The server computers 110, 120, 130 are arranged to provide software-implemented services e.g. for the purposes of receiving transactions, e.g. purchase orders or invoices, sending transactions, modifying contents of the transactions and providing application services based on the content of the transactions.

The services available at the server computer 120 may also comprise value-add application services related to the transactions, e.g. providing financing for an invoice. The application services may be implemented e.g. using HTTP and HTML technologies as well as other web technologies, e.g. Java and JavaScript well known to a person skilled in the art.

In a preferred embodiment, the computer acting as the source of transactions 110 is adapted to obtain a transaction e.g. from a customer's system, e.g. an invoice from an invoicing system, amend the transaction with invitation token data of an embodiment of the present invention and send the transaction to the computer 130 acting as the destination of transactions. The computer 110 is also adapted to create an invitation token or request the invitation token e.g. from the computer 120 to be added to the transaction to be sent to the destination 130. Further, the computer 110 may be adapted to associate a service with the transaction of the invitation token. Yet further, the computer 110 may be adapted to send transaction-related supplementary data to the computer 120. Such data may comprise data that the computer 130 is not able to receive e.g. because the data has a format or content that is not supported by the services available at the computer 130.

In a preferred embodiment, the computer 120 is adapted to receive a request message from the computer 110 to create an invitation token for a transaction to be transmitted from computer 110 to computer 130. The request message may be implemented using some suitable service invocation mechanism well known to a person skilled in the art, e.g. as a URL having parameters. The computer 120 may further be adapted to receive transaction-related supplementary data from the computer 110. For example, a service executable on computer 120 may accept an image of an invoice from the source of invoice transactions 110. The computer 120 may also accept e.g. event data, e.g. status change events, related to the transaction. In a preferred embodiments, the computer 120 comprises means for associating with the invitation token at least one service, e.g. rendering of the image of an invoice, available e.g. at the computer 120.

The computer 130 is adapted to receive the transaction sent from the computer 110. In an embodiment, the transaction has a format supported by both the sender system 110 and the receiving system 130. The format may be e.g. a XML-based (Extensible Markup Language) format. In an embodiment, the format of the transaction may be a standard format, e.g. PEPPOL (Pan-European Public Procurement On-Line) or UBL (Universal Business Language). The received transaction comprises in a data field reserved for a URL the token created for the transaction e.g. by the service of the computer 120. The token is advantageously formatted as a URL comprising at least information derived from the identifier of the source of the transaction. In an embodiment, the computer 130 is further adapted to forward the transaction with the token URL to a customer's computer system, e.g. to a purchase invoice processing system.

The arrangement may further comprise terminal computers 101, 102, that are also communicatively connected to the network 140 using connections 103, 104. The terminal computers may comprise software-implemented functionality for e.g. viewing a transaction or using a value-add service related to the transaction. In a preferred embodiment, the functionality is accessible at the terminal via a web browser.

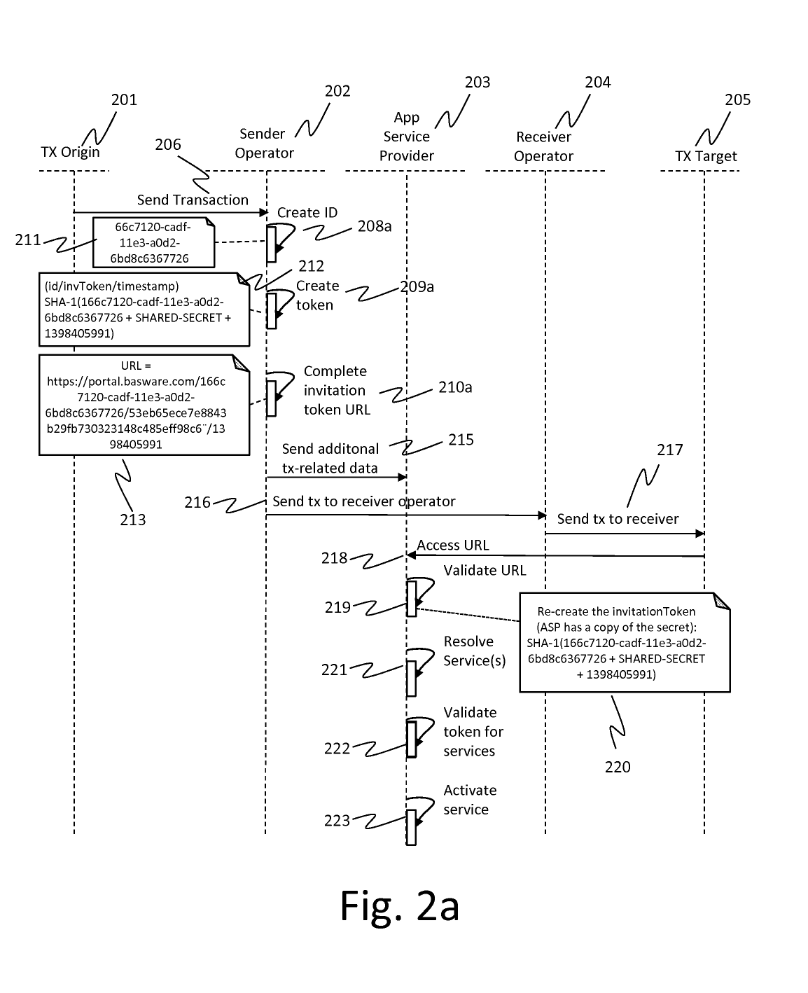

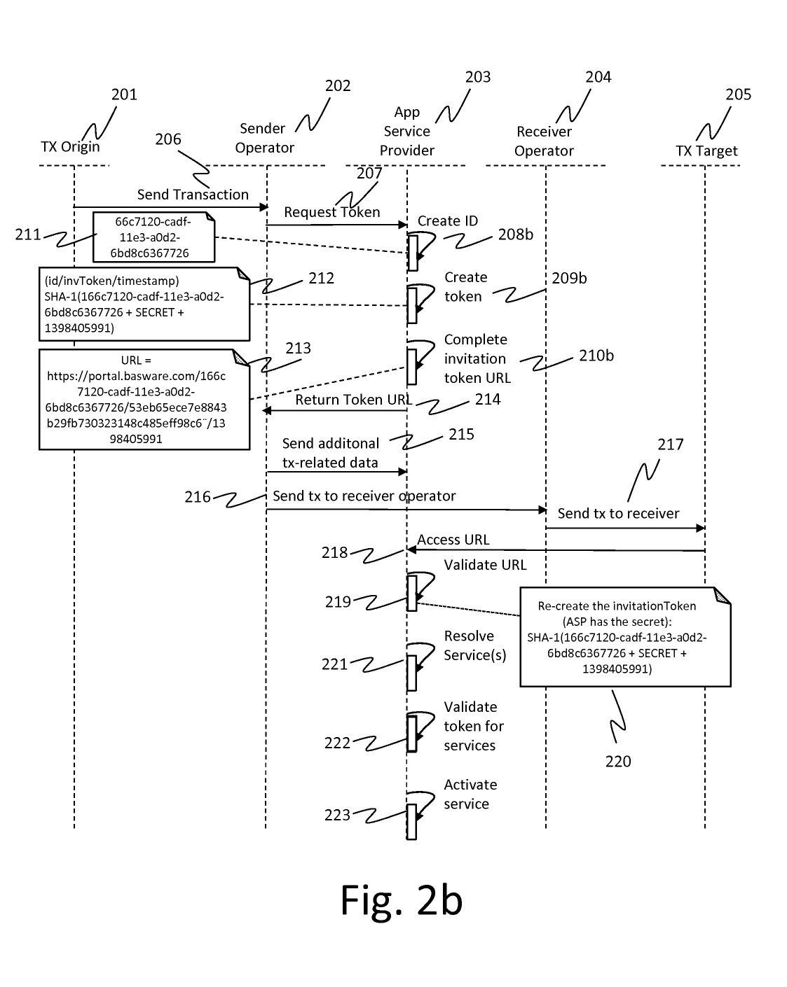

FIG. 2a depicts an event diagram that illustrates a preferred embodiment of the methods and arrangements of the present invention. The participants of the arrangement typically comprise a transaction origin 201, e.g. an invoicing system of a seller organization. The transaction origin is communicatively connected to a sender operator's system 202 (110 in FIG. 1), which is further communicatively connected to the application service provider system 203 (120 in FIG. 1) and to the receiver operator's system 204 (130 in FIG. 1).

The receiver operator is arranged to transmit transactions, e.g. electronic invoices and/or purchase orders, to the transaction target system 205, e.g. the invoice approval system or the order management system of a business organization.

In step 206 of the event diagram, the transaction origin system 201 sends a transaction to the sender operator's system 202. In an embodiment, the transaction origin 201 and the sender operator's system 202 may reside in the same computer system. The transaction origin system, e.g. an invoicing system, may thus comprise also the functionality of the sender operator or the sender operator system may comprise an invoicing system.

In the shown embodiment, when the sender operator 202 receives the transaction, it creates the token of an embodiment of the present invention utilizing a secret shared with application service provider system 203 (120 in FIG. 1).

In the embodiment shown herein, the creation of the token comprises three steps that are executed in the system 202. First, a unique ID (within the domain of the application service provider 203) is created 208a for the transaction, if such ID does not exist yet. In a preferred embodiment, the ID is able to identify also the transaction origin system 201. The ID may comprise components. In the example ID shown in 211, the beginning of the ID string “66c7120” may identify the origin system, the string “cadf” may identify the type of the transaction and the rest of the string identifies the transaction uniquely within the transaction origin system. Next, a hash value belonging to the token is created 209a by concatenating at least part of the document id, the shared secret known both to the system 202 and to the app service provider 203 (120 in FIG. 1) and a timestamp and calculating a hash value of the concatenated string using a suitable hash algorithm. An example of the token is shown in box 212. To complete the creation of the token, a URL is created 210a in the system 202 by concatenating a domain name (in the example shown in 213 the domain is “https://portal.basware.com/”), (the part of) the document ID that is used in the hash, the calculated hash value and a timestamp which represents the creation time of the token. The sender operator now amends the transaction data (e.g. XML data) with the created URL. In many standard transaction formats there is a URL field available for a URL relevant to the transaction. The sender operator may now send 215 additional data related to the transaction to the application service system 203 which stores the data. The additional data is accompanied by the transaction ID created in step 208. The additional data may for example comprise data that is not supported by the receiver operator 204 of the system but that is nevertheless required by the recipient of the transaction 205. Such data may be for example the document image of an electronic invoice or a state change event related to the transaction. The additional data may be sent to the application service provider 203 at any point of time, before or after sending the actual transaction to the receiver operator 204. In an embodiment, the additional data may be encrypted at the application service provider system 203 e.g. using the secret of system 203 associable with the system 202.

In step 216, the sender operator sends the amended transaction to the receiver operator 204 which further forwards 217 it to the transaction target system 205. The transaction target system is adapted to display the Invitation Token URL 213 in the user interface of at least one of its application service. The user of the application service of the transaction target 205 may now click 218 the URL, which takes the user to an application service provided by the application service provider 203. At the application service system, the URL is first validated 219 by reconstructing the token from its components (e.g. the id, the secret indicating the trust relationship and the timestamp) and the hash value of the reconstructed token is compared with the hash value of the received token. An example about the re-construction of the token is shown in box 220. If the URL is valid, the services that have been activated for the receiver 205 of the transaction e.g. by the sender operator 202 are resolved 221. Note that the receiver organization identity is resolvable from the unique ID of the transaction. Once the services have been identified, the validity of the services for the recipient and the transaction may be further validated 222 using the information of the token, e.g. the timestamp. For example, a service may be available for the transaction for only a limited period of time. Finally, the services that are deemed valid for the recipient and the transaction are activated 223. The activated service may e.g. display the image of the electronically transmitted invoice on the terminal device 102 of the user of the recipient system.

FIG. 2b depicts an event diagram that illustrates another preferred embodiment of the methods and arrangements of the present invention. The participants in this embodiment are similar to those of FIG. 2a. In the shown embodiment, when the sender operator 202 receives the transaction, it requests 207 the token of an embodiment of the present invention from the application service provider system 203 (120 in FIG. 1) using an authenticated request. The embodiment shown in FIG. 2b thus shows the creation of the token (209b-210b) at the Application Service Provider system 203 upon the authenticated request 207 instead of creating the token in system 202 utilizing a shared secret as shown in FIG. 2a. The authentication may be performed e.g. using user account credentials of a user representing the system 202 in the system 203. In both embodiments (FIGS. 2a and 2b) the token is created utilizing a secret that is known to the system 203 and that is associable by the system 203 with the system 202 that amends the transaction with the token.

In the embodiment shown herein, the creation of the token comprises three steps. First, a unique ID (within the application service provider domain) is created 208b for the transaction, if such ID does not exist yet. In a preferred embodiment, the ID is able to identify also the transaction origin system 201. The ID may comprise components. In the example ID shown in 211, the beginning of the ID string “66c7120” may identify the origin system, the string “cadf” may identify the type of the transaction and the rest of the string identifies the transaction uniquely within the transaction origin system. Next, a hash value belonging to the token is created 209b by concatenating at least part of the document id, a requestor-related secret known to the app service provider 203 (120 in FIG. 1) and a timestamp and calculating a hash value of the concatenated string using a suitable hash algorithm. The requestor is identified by the authentication of the request 207 utilizing e.g. the credentials of the requestor 202 in the system 203. An example of the token is shown in box 212. To complete the creation of the token, a URL is created 210b by concatenating a domain name (in the example shown in 213 the domain is “https://portal.basware.com/”, (the part of) the document ID that is used in the hash, the calculated hash value and a timestamp which represents the creation time of the token. The completed token is returned 214 to the requesting system, which in the shown embodiment is the sender operator 202. The flow of events continues from this on (steps 215-223) as in the description of FIG. 2a.

It is noteworthy that the transaction to be transmitted from the system 201 to system 205 may be amended with the invitation token of an embodiment of the present invention by any participant of the transaction transmission network that is adapted to send and/or receive the transaction in the transaction transmission network. It is thus possible, that the transaction is amended with the invitation token e.g. by system 201, 204 and/or 205. In order to amend the transaction with the token, the amending system must have established a trust relationship with the application service providing system 203 e.g. by establishing a shared secret with the system 203 or by establishing a user account at the system 203. The amending system needs also to either request the token from the system 203 (steps 207, 214 of FIG. 2b) or implement itself the token creation routines (steps 208a-210a of FIG. 2a).

It is also noteworthy, that the transaction may comprise multiple invitation tokens, e.g. one for each system that has established a trust relationship with the application service system 203. The tokens may be concatenated into the same URL or they may be amended to the transaction as separate URLs.

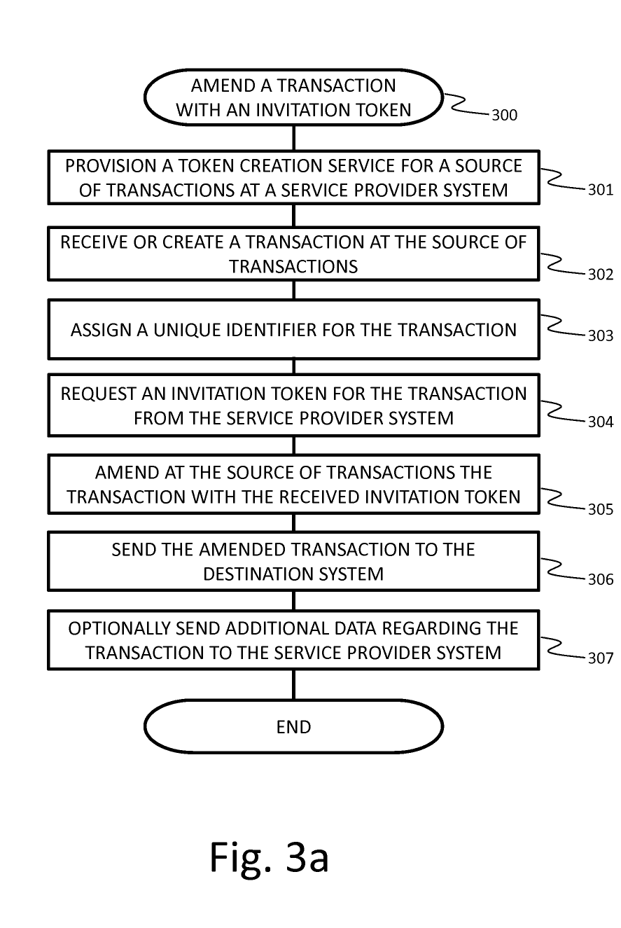

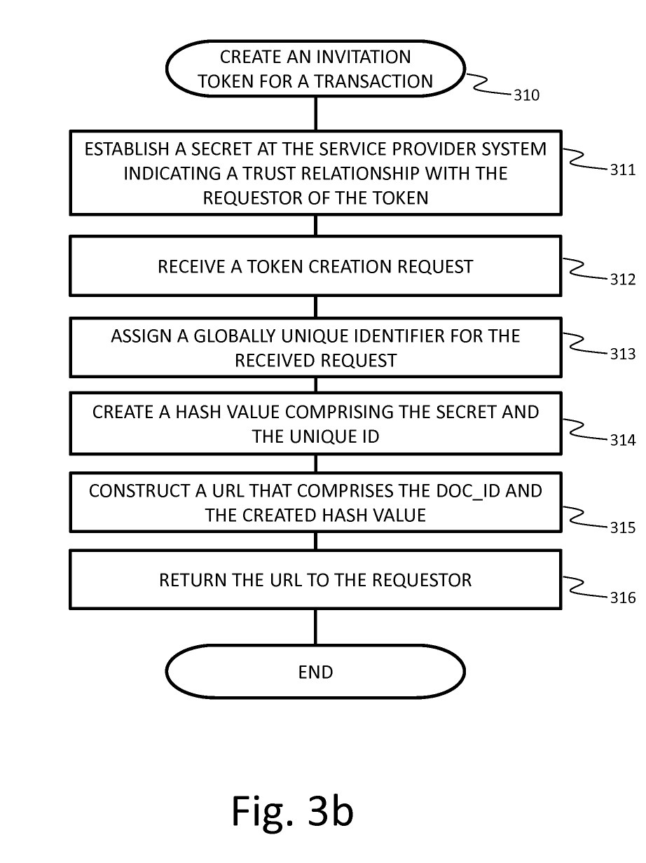

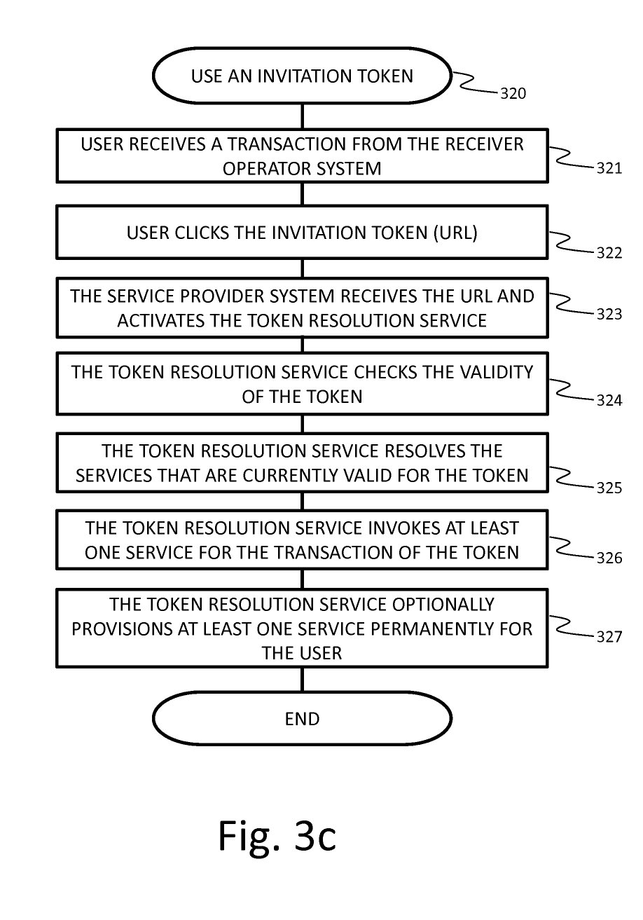

FIG. 3a depicts a flow chart of a method for amending a transaction, e.g. an invoice or purchase order, with an invitation token according to an embodiment of the present invention. In an embodiment, the invitation token is requested by the source of transactions (110 in FIG. 1) from the token creation service available at the computer system 120. In order for the source of transactions 110 to be able to use the token creation service, the service needs to be provisioned 301 for the source of transactions 110. In an embodiment, the provisioning comprises creation of a user account at the token creation service for the source of transactions (202 in FIG. 2) and establishing at the system 120 a secret that is associable with the source of transactions. In a preferred embodiment, the secret is a cryptographic key, e.g. a symmetric key. The secret may also be one entered by the user of either systems. The step of provisioning the token creation service 301 is required only once for a source of transactions 110. If the service has already been provisioned, this step is not necessary. The user of the source of transactions 110 may also specify at this phase, which application services of the application service system 120 shall be made available (subscribed) to the recipient(s) of the transaction comprising the invitation token. The subscription of application services may also be performed later, even after the transaction comprising the invitation token has already been sent to the recipient.

In step 302, the source of transactions 110 creates or receives from another system a transaction, e.g. an electronic invoice, a purchase order or any other electronic (business) transaction. Next, in step 303, the transaction is assigned a unique identifier. The identifier must be unique at least in the scope (domain) of the application service provider system 120. In a preferred embodiment, the unique identifier is provided by a service of the service provider system. Next, in step 304, the source of transactions 110 requests an invitation token for the transaction from the token creation service of the application service provider system 120. In another embodiment, the token creation service may be implemented by the source of transactions 110 itself. The transaction is then amended with the received invitation token 305. The amended transaction may now be sent 306 to the destination system (e.g. 130 in FIG. 1 or 204 in FIG. 2). Supplementary data related to the transaction, e.g. the document image of an XML-formatted electronic invoice, may be sent to the system 120 in step 307. The supplementary data is identifiable by the unique identifier of the transaction generated in step 303.

The flow chart of FIG. 3b shows in more detail the creation of the invitation token 310 for a transaction according to an embodiment of the present invention. In step 311, a secret is established at the service provider system 120. The secret is associable with the sender operator 110 and indicates a trust relationship between the systems 110 and 120. In an embodiment, the sender operator 110 has a copy of the secret thus making the secret a shared secret. This step is optional, if the secret associating the systems with each other has already been established. In step 312, a token creation request is received from the source of transactions, e.g. from the sender operator system 110 (202 in FIG. 2). Then a globally unique identifier is established 313 for the transaction of the received request if such identifier has not yet been assigned with the transaction. An example of such identifier is provided in box 211 of FIG. 2. In an embodiment, the identifier comprises components identifying the source of the transaction, the type of the transaction as well as the transaction itself. Next, a hash value is created from the secret and the unique ID 314. The source data of the hash value may comprise also other information regarding the transaction, e.g. a timestamp. In step 315, a URL is constructed that comprises at least part of the identifier and the created hash value. An example about such URL is shown in box 213 of FIG. 2. In an embodiment, only a part of the unique transaction identifier is used in the token and in the URL. For example, the full identifier may have three parts: Organization ID, transaction type and transaction ID (within organization and type). The token may in some embodiments use e.g. only the organization ID and transaction type parts of the identifier. Finally, the constructed URL is returned 316 to the requestor, e.g. the sender operator 202.

FIG. 3c shows a flow chart about using 320 the invitation token of an embodiment of the present invention. In step 321, a user (e.g. of system 205) receives a transaction, e.g. an electronic invoice from the receiver operator system (e.g. of system 204). The system 205 has a user interface that shows the URL comprising the invitation token. The user may now click the URL 322 which takes 323 the user to a token resolution service of the application service system 203. The token resolution service checks 324 the validity of the token. In a preferred embodiment, this is performed by reconstructing the hash value of the token from its components, e.g. (a part of) the ID of the transaction, the secret (which the system 120 knows) and the timestamp. Next, the token resolution service resolves 325 the services that are currently valid for the organization and/or transaction of the token. Then the token resolution service provisions or invokes at last one service for the organization and/or transaction of the token 326. The provisioned/invoked service may optionally be made permanently available for the user representing the recipient organization of the token 327.

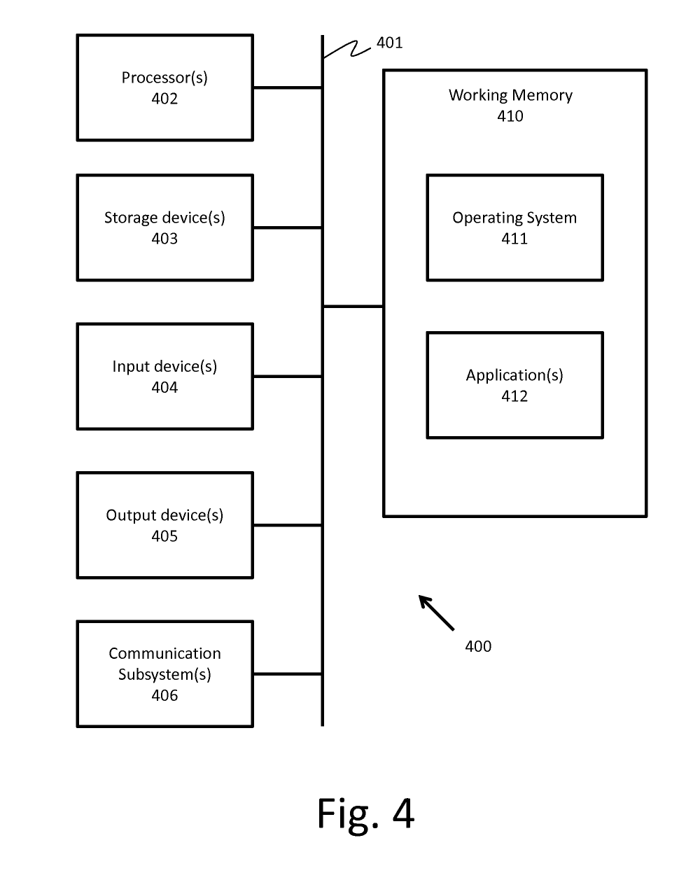

FIG. 4 shows a schematic illustration of one embodiment of a computer system that can perform the methods of the described embodiment. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 401 (or may otherwise be in communication, as appropriate). The hardware elements can include one or more processors 402, communication subsystems 403, one or more input devices 404, which can include without limitation a mouse, a keyboard and/or the like; and one or more output devices 505, which can include without limitation a display device, a printer and/or the like. The computer system 400 may further include (and/or be in communication with) one or more storage devices 403. The computer system 400 also can comprise software elements, shown as being located within the working memory 410, including an operating system 411 and/or other code, such as one or more application programs 412, which may comprise computer programs of the described embodiments, and/or may be designed to implement methods of the described embodiments of a computer-method of the embodiments as described herein.

At least some embodiments include a program storage device readable by a machine, tangibly embodying a program of instructions executable by the machine to perform a computer-method of an embodiment of the present invention.

Although specific embodiments have been described and illustrated, the embodiments are not to be limited to the specific forms or arrangements of parts so described and illustrated.

1. A computer executable method for a first computer system to amend a transaction adapted to be sent from the first computer system to a recipient system with an invitation token to invite a recipient system's user to use a service provided by a second computer system, wherein the method comprises steps:
a. requesting by the first computer system the creation of the invitation token comprising information indicating a trust relationship between the first computer system and the second computer system,
b. amending by the first computer system the transaction with a URL comprising the created invitation token, and
c. sending the amended transaction to the recipient system.

2. A method according to claim 1, wherein the data of the invitation token comprises a hash value calculated from at least the information indicating the trust relationship between the first computer system and the second computer system.

3. A method according to claim 1, wherein the step of requesting by the first computer system the creation of the invitation token comprises the steps of sending a request message to the second computer system and receiving from the second computer system a response message comprising the requested invitation token.

4. A method according to claim 3, wherein the information indicating the trust relationship between the first and the second computer system comprises secret information stored in the second system wherein the secret information is associable with a user account representing the first computer system in the second computer system.

5. A method according to claim 1, wherein the step of requesting by the first computer system the creation of the invitation token comprises invoking a service in the first computer system to create the invitation token.

6. A method according to claim 1, wherein the data of the invitation token further comprises at least one of the following:
a. identifier of the origin of the transaction,
b. identifier of the type of the transaction,
c. identifier of the transaction, and
d. timestamp of the transaction.

7. A method according to claim 1, wherein the method further comprises the step of sending data related to the amended transaction from the first computer system to the second computer system.

8. A computer executable method for resolving at least one service for the recipient of the transaction of claim 1 in the second computer system, wherein the method comprises steps:
a. receiving from the recipient system an invitation token comprising information indicating a trust relationship between the second and the first computer systems,
b. verifying the validity of the invitation token, and
c. resolving at least one service provided by the second computer system wherein the service has been made available for the recipient of the transaction by the first computer system.

9. A method for providing a service on a transaction in a first computer system communicatively connectable to at least one second and at least one third computer system, wherein the method comprises steps:
a. storing information indicating a trust relationship between the first system and the second system,
b. receiving from the second computer system the identifier of the transaction and some data associable with the transaction,
c. associating at least one service with the transaction,
d. receiving an invitation token from a third computer system wherein the invitation token comprises the transaction identifier and data derived from the data indicating trust between the first system and the second system,
e. validating the received invitation token using the information indicating trust relationship between the first and the second system, and
f. executing the service associated with the validated invitation token.

10. A first computer system communicatively connectable to at least one second and at least one third computer system and adapted to provide a service on a transaction, the first computer system comprising means for:
a. storing information indicating a trust relationship between the first system and the second system,
b. receiving from the second computer system the identifier of the transaction and some data associable with the transaction,
c. associating at least one service with the transaction,
d. receiving an invitation token from the third computer system wherein the invitation token comprises the transaction identifier and data derived from the data indicating trust between the first system and the second system,
e. validating the received invitation token using the information indicating trust relationship between the first and the second system, and
f. executing the service associated with the validated invitation token.
